(19) United States
(12) Patent Application Publication
(10) Pub. No.: US 2013/0253957 A1
(43) Pub. Date: Sep. 26, 2013

(54) Method, Apparatus and System for Providing Insurance Coverage and Claims Payment for Single Event Surgical and Diagnostic Procedures

(71) Applicant: Barry S. Markman, Las Vegas, NV (US)

(72) Inventor: Barry S. Markman, Las Vegas, NV (US)

(21) Appl. No.: 13/897,419

(22) Filed: May 19, 2013

Related U.S. Application Data
(63) Continuation-in-part of application No. 12/009,180, filed on Jan. 16, 2008, now abandoned.
Application No. 12/009,180 is a division of application No. 10/879,651, filed on Jun. 28, 2004, now abandoned.
(60) Provisional application No. 60/484,135, filed on Jun. 30, 2003.

(51) Int. Cl. G06Q 40/08

(52) U.S. Cl. CPC G06Q 40/08
USPC 705/4

(57) ABSTRACT

A method and system are provided for determining whether to issue insurance coverage for one or more specific events, such as a specific surgical event or diagnostic procedure. The method and system include consideration of a variety of risk criteria associated with the event or procedure, as well as policy coverage components. Preferably, old and new risk data is utilized to determine posterior possibilities for events associated with the event or procedure. Risk data is utilized to determine whether to issue policies, and to determined policy coverage where policies are to be issued, so as to minimize premiums to the insured and maximize profits to the company.

### RELATED APPLICATION DATA

This application is a continuation-in-part of U.S. application Ser. No. 12/009,180, filed Jan. 16, 2008, which is a divisional of U.S. application Ser. No. 10/879,651, filed Jun. 28, 2004, now abandoned, and claims priority to U.S. Provisional Application Ser. No. 60/484,135 filed Jun. 30, 2003.

### FIELD OF THE INVENTION

The present invention relates to a system, method and apparatus for providing insurance coverage and claims payment.

### BACKGROUND OF THE INVENTION

For multiple reasons, the number of outpatient procedures in accredited Ambulatory Surgery Centers has increased significantly in the past decade. There are well over 40 million surgical procedures performed each year, and over 50% or these are conducted as outpatients.

Patients have at their disposal various methods to purchase insurance to cover the peril of surgery and diagnostic procedures. Currently, insurance coverage is provided in general policies such as health, term or whole life, disability, and liability insurance. The insurer insures a large number of insureds against a particular peril, charging premiums to each and relying on the likelihood that the peril will only come to pass for a small number of insureds.

Specific statistics and probabilities are utilized to investigate potential insureds to determine whether or not their behavior makes them more likely to suffer the peril to be insured against, turning down those who exhibit risky behavior, or charging a higher premium. The insurer's profit depends on the analysis of these specific statistics and probabilities to collect more in premiums that it pays in claims. Traditional insurance in those instances mentioned above will have the insured pay premiums for coverage during a specific period of time and not on a specific surgery or diagnostic procedure.

There are several drawbacks of the General Policies. First, the General Policies that cover health related events currently base their premiums on coverage for a period of time, not a single event. In these circumstances, the individual is committed to paying premiums on an ongoing basis to avoid cancellation and remained covered for health related perils. An example of coverage for a non related health care single event is that of “flight insurance.” In this instance, coverage is provided per an event, not for a period of time.

Currently, there is only one policy that provides coverage to a party for a health related single event and post operative complications that may occur, CosmetAssure. There are several major drawbacks to CosmetAssure. The first is that the policy provides benefits specifically for hospitalization after a complication related to that surgery. CosmetAssure does not provide benefits for Death, Disability, Dismemberment and Medical Malpractice Liability. Secondly, benefits are paid on a reimbursement basis for expenses incurred, and not an indemnity basis to the patient. Thirdly, CosmetAssure is limited in that it covers only specific Cosmetic Procedures. And finally, CosmetAssure is purchased as part of the procedure and “underwritten” by the Surgeon's participation in CosmetAs sure, not on a full complement of underwriting criteria. As stated on the CosmetAssure website, “Patients of Participating Surgeons are automatically covered for certain medical expenses that arise from an unplanned hospitalization following one or more of the covered procedures performed by a Participating surgeon . . . each patient undergoing a Covered Procedure by a participating Surgeon is automatically covered. There is no case by case selection by the Surgeon or the Patient.” Therefore, the decision to purchase the coverage, either as a stand alone insurance policy or integrated as a rider on an existing policy, is not made by the Individual, employer, or Association. In turn, the decision to purchase this limited coverage was made by the Surgeon, not by an Individual, employer, or Association, on a mandatory or voluntary basis. In this arrangement, the policy coverage as viewed by the patient is a single event, but the actual coverage is directed to a wide variety or number of activities which a surgeon is involved in.

In summary, in order to provide underwriting, pricing, and a benefit schedule for a full compliment of single event surgical and diagnostic procedures, a need exists for a more sophisticated system and methodology to analyze health related statistics and probabilities and the apparatus to process the statistical data.

### SUMMARY OF THE INVENTION

The object of this business method is to provide insurance coverage for a defined peril, a single event diagnostic and or surgical procedure. To provide coverage for a large number of procedures and a variety of benefits, the invention was developed to process current and future statistics in regard to the probabilities associated with each procedures' mortality and morbidity, and in turn, the relative likely impact of premiums of the insured and profits on the insurer.

In accordance with the present invention, this invention relates to a system, method, and apparatus for providing insurance coverage and claims payment for patients with respect to a single event surgery diagnostic or surgery procedure. In one embodiment, components of a policy for an event or procedure include: (1) criteria for the extent of coverage, including classifications and types of surgical and diagnostic procedures; (2) criteria for type of coverage, including death, short term and long term disability, dismemberment, unexpected hospitalization, medical malpractice liability, and other complications inherent of a surgery or diagnostic procedure; (3) criteria for type of insured, including individuals and employer-association groups; (4) criteria for type of policy, including stand alone or as a rider on a new or existing policy; (5) criteria for premiums of said policies, (6) schedules of benefits, including if they should be paid on a reimbursement or indemnity basis; and (7) criteria to the type of offering, if the policy is to be offered to the insured on a voluntary or involuntary basis.

The system and method are actuarially responsive to dependant variables including but not limited to: ICD-10CM diagnostic codes; CPT procedural codes for surgical and diagnostic procedures; ASA and NYHA patient anesthesia risk assessment indexes; certification of the center where the surgical or diagnostic procedure is performed; national vital statistics on the number and type of surgical and diagnostic procedures performed; actuarial tables for life expectancy; data for surgical and procedural mortality and morbidity; patient application based on social, demographic, surgical, anesthetic, and patient co morbid factors; and current health, life, disability, accident, death, and dismemberment of the insured and the extent they integrate with the single event surgical and procedure policy.

In accordance with the present invention, there is provided a system and method comprising criteria for various form of coverage for a single event inpatient and outpatient surgery or procedure for the insured. The core policy provides a lump-sum benefit in the event of including but not limited to, death, short and long term disability, dismemberment, or any a complication inherent to the surgical and diagnostic procedure. A first supplemental policy is based on a reimbursement or indemnity schedule for hospitalization as a result of the procedure and its post operative period. In accordance with this invention, a second supplemental policy is based on an indemnity and/or reimbursement schedule to provide coverage to the insured for an incidence of medical liability insurance related to the single event procedure. Means definition will apply to the single event surgical and diagnostic procedure. Injury from the procedure must be unintentional regardless of cause. Nonetheless, in jurisdictions that allow a supplemental rider to insure the patient for damages in the event of a medical error or malpractice, such will be available.

In accordance with the present invention, there is provided a system and method for data collection, processing, and payment of claims for various forms of coverage for a patient or other interested parties for a procedure. An apparatus for performing the method is also provided, as well as a machine-readable data storage medium on which is encoded a set of machine-executable instructions for performing the method and systems.

Further objects, features, and advantages of the present invention over the prior art will become apparent from the detailed description of the drawings which follows, when considered with the attached figures.

### DESCRIPTION OF THE DRAWINGS

FIG. 1 illustrates criteria associated with a single surgical event or diagnostic procedure;

FIG. 2 illustrates components of a policy of the invention;

FIG. 3 is a flow diagram of a method of determining posterior probabilities associated with surgical events or diagnostic procedures; and

FIG. 4 illustrates a method of processing policy applications, issuing policies and processing claims for surgical events/diagnostic procedures.

### DETAILED DESCRIPTION OF THE INVENTION

The invention comprises systems, methods and apparatus for providing assessing and providing insurance coverage. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, one embodiment of the invention comprises a method of determining whether to provide insurance coverage, and if so, determining the coverage including the terms thereof. Preferably, the assessment of coverage and coverage provided is directed to particular events, such as a single surgical event or single diagnostic procedure. Other aspects of the invention comprise systems and apparatus for implementing various methods, and preferably the method of the invention.

One aspect of the invention is a method for assessing the risks associated with a surgical event or diagnostic procedure. In a preferred embodiment, this method includes the use of a various criteria for assessing or determining total risk.

In one embodiment of the method, factors relating to the patient's risk of mortality and morbidity associated with the surgical event or diagnostic procedure are evaluated to determine a total risk value. In one embodiment, this risk value is determined in accordance with the following formula:

PtCov=a.suba (sub.a)+a.sub.b (sub.b)+a.sub.c (sub.c)+ . . . a.sub.j (subj)

In this formula, each x.sub.i is a weight factor related to the patient's risk of mortality and morbidity during the surgical or diagnostic procedure.

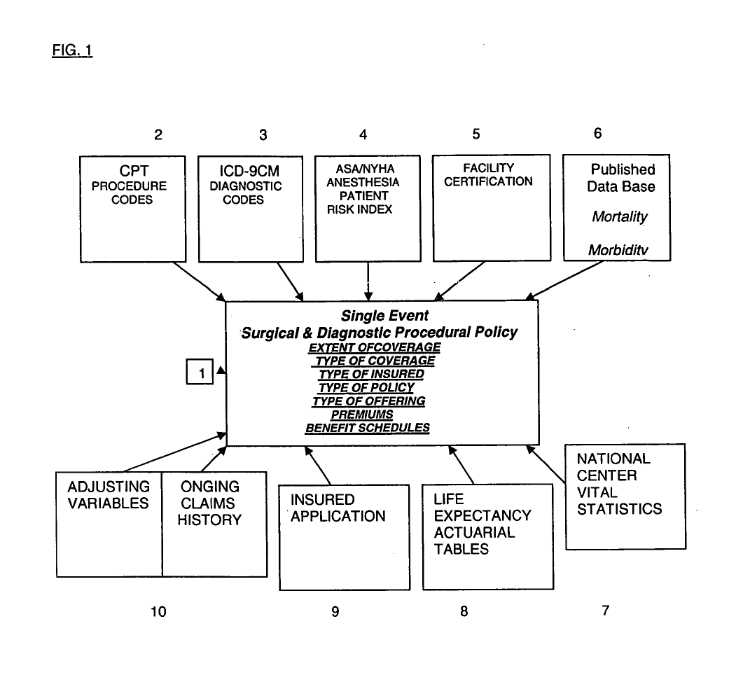

One embodiment of the invention comprises factors and criteria which are utilized to determine or influence the weighted factors for determining the risk. In one embodiment, as illustrated in FIG. 1, these factors include, but are not limited to:

(a) ICD-10CM diagnostic codes (2), including:

Whether the ICD-9CM code was for outpatient or inpatient;

Whether the ICD-9CM code was for a based on trauma or elective surgery; and/or

Current morbidity and mortality statistics of the procedure

(b) CPT procedural codes for surgical and diagnostic procedures (3), including:

CPT designation of the body region being operated;

CPT designation whether the procedure is the result of an existing complication; and/or

CPT designation whether the procedure is being performed with other procedures

(c) ASA and NYHA Patient Anesthesia Risk Assessment Indexes (4), including:

Anesthetic risk of the patient

(d) Certification of the Center where the Surgical or Procedure is performed (5), including:

Whether the Surgical Facility has been Certified through a National Accreditation

(e) Data Base for Surgical and Procedural Mortality and Morbidity (6), including:

Data collection and collation from published statistics on Morbidity and Mortality Of

Surgical and Diagnostic procedures

(f) Actuarial Tables for Life Expectancy (7)

(g) National Vital Statistics on the number and type of surgical and diagnostic procedures performed (8), including:

Data collection and collation demonstrating trends from the National Center of Health

Statistics

(h) Patient application based on social, demographic, surgical, anesthetic, and patient co-morbid factors (9), including:

The data collection and correlation of individual insured's medical history;

Whether the patient is required to complete an application;

Whether the Policy should be guaranteed or modified guaranteed issue to the patient; and/or

Particular medical conditions that will act as exclusions for patient participation in the Policy and

(i) Ongoing claims history and weight adjustments to the multiple regression analysis (10)

Of course, additional or different criteria might be used, depending on the particular surgical event or diagnostic procedure for which the risk is being assessed. Further, as disclosed below, in one embodiment, the weighted factors may be normalized.

Referring to FIG. 1, the weighted factors are used to assess risk associated with a surgical event or diagnostic procedure for purposes of assessing risks associated with insurance policy (1) coverage. In other words, the policy issuer uses the risks analysis to determine, in part, the risk of loss associated with issuance of the policy. As described below, this is important to the policy issuer's optimization of profits.

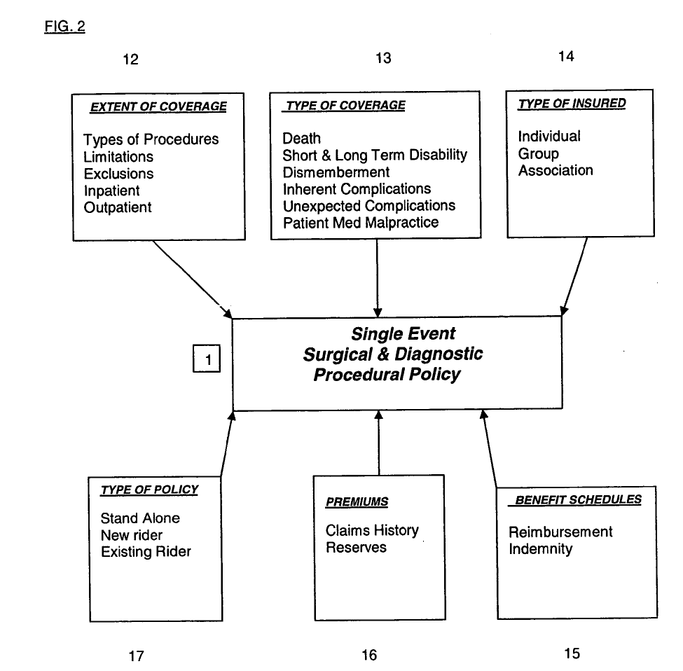

Another aspect of the invention is a insurance policy pertaining to a single surgical event or diagnostic procedure. FIG. 2 illustrates one or more components of a policy (1) in accordance with one embodiment of the invention. In one embodiment, these components comprise:

(a) Extent of Coverage (12), including:

Types of Procedures;

Inpatient; and/or

Outpatient

(b) Types of Coverage (13), including:

Death;

Short and Long Term Disability;

Dismemberment;

Inherent Complications in the specific Surgery or Diagnostic procedure;

Hospitalization; and/or

Patient Medical Malpractice Liability by Surgeon

(c) Types of Insured (14), including:

Individual;

Group; and/or

Association

(d) Benefit Schedules (15), including:

Reimbursement; and/or

Indemnity

(e) Premiums (16), including:

Claims History; and/or

Reserves

(f) Types of Policy (17), including:

Stand alone Policy;

New Rider on offered health related Policies; and/r

Existing Rider on offered health related Polices

The policy (1) of the invention may have other components than those necessarily detailed here, depending upon the particular surgical event(s) or diagnostic procedure(s) and other factors.

Another aspect of the invention is a method of continually processing, updating, collating, and correlating probabilities and data pertinent to the single event surgical and diagnostic procedure policy, including the risks of events occurring as covered by the policy.

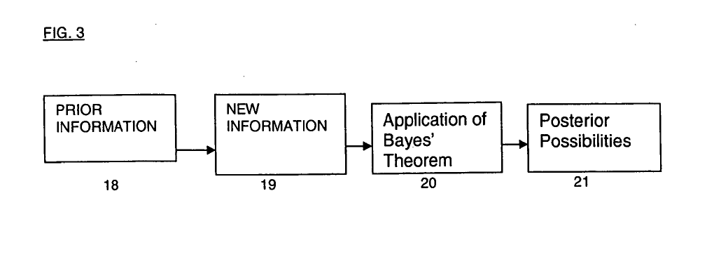

Referring to FIG. 3, in one embodiment, prior data and statistics (18) and new information and claims data (19) is processed. Preferably, this information is used in a Bayes' theorem calculation (20) to determine posterior probabilities (21) (i.e. the possibility of an event occurring) for various events/procedures. As is known in the art, in accordance with Bayes' theorem, a matrix or list of possible outcomes is constructed. As used herein, this matrix is referred to as a variance-covariance matrix. For each hypothesis, a conditional probability for that outcome is calculated. Actual outcome information is then associated with the theorem to compute revised posterior probabilities for each hypothesis.

In accordance with the invention, once an adjusted variance-covariance matrix has been formed, a minimum variance portfolio can be determined using optimization techniques. The optimization techniques that are used generally have, underlying them, some form of differentiation to select a minimum variance.

The result of the optimization of the variance-covariance matrix will be a collection of coefficients or weights x.sub.ip representing the relative risk of the surgical event(s) or diagnostic procedure(s) in which positions should be established to provide the desired coverage in accordance with the invention. If the coefficients are normalized so that they total 1.0, that normalized set of coefficients could be thought of as representing on “unit” of surgical event or diagnostic procedure coverage. The number of “units,” and thus the total number of potential events representing mortality and morbidity outcomes of the procedures, would depend on the amount of coverage required or desired by the insured.

In a preferred embodiment of the invention, where E(R.sub.e) is some given level of expected return for the Policy, rho . . . sup1(R.sub.p) stands for the variance of return of the Policy as a whole, and E(R.sub.i) stands for the expected return of the specific form of coverage provided. The problem stated in the equations is to choose proportions x.sub.ip, i=1 . . . n, that minimize the variance of the risk of the form of coverage offered, subject to the constraints, so that expected return of the coverage form is equal to E(R.sub.e), and the sum of the proportions invested in the coverage form is 1.0.

In other words:

Minimize .rho . . . sup1 (R.sub.p), with

x.sub.ip, i=1, . . . ,n

subject to the constraints (see above).

In this model, .rho . . .sup1(R.sub.p) represents the variance of exposure to event/procedural morbidity or mortality. E(R.sub.i) denotes liability exposure associated with coverage I, and E(R.sub.e) the liability exposure of the coverage as a whole.

In accordance with the novelty of this invention, revising probabilities when new information is obtained is an important phase of probability analysis. The analysis with initial or prior probability estimates for mortality and morbidity of events/procedures are updated when additional information is obtained. Given this new information, updated prior probability values will be updated by calculating revised probabilities, referred to as posterior probabilities.

In accordance with the present invention, there is provided a system and method for data collection, processing, and payment of claims for various forms of coverage for a patient or other interested parties for an event/procedure. Among other things, the method and system are configured to track of covered parties, premium payments received, claims made and paid, computing the minimum variance of the policy net revenue and reserves, and specifically calculating triggering events, including outcomes of mortality and morbidity of events/procedures and their effect on the coverage, and payment of a claim.

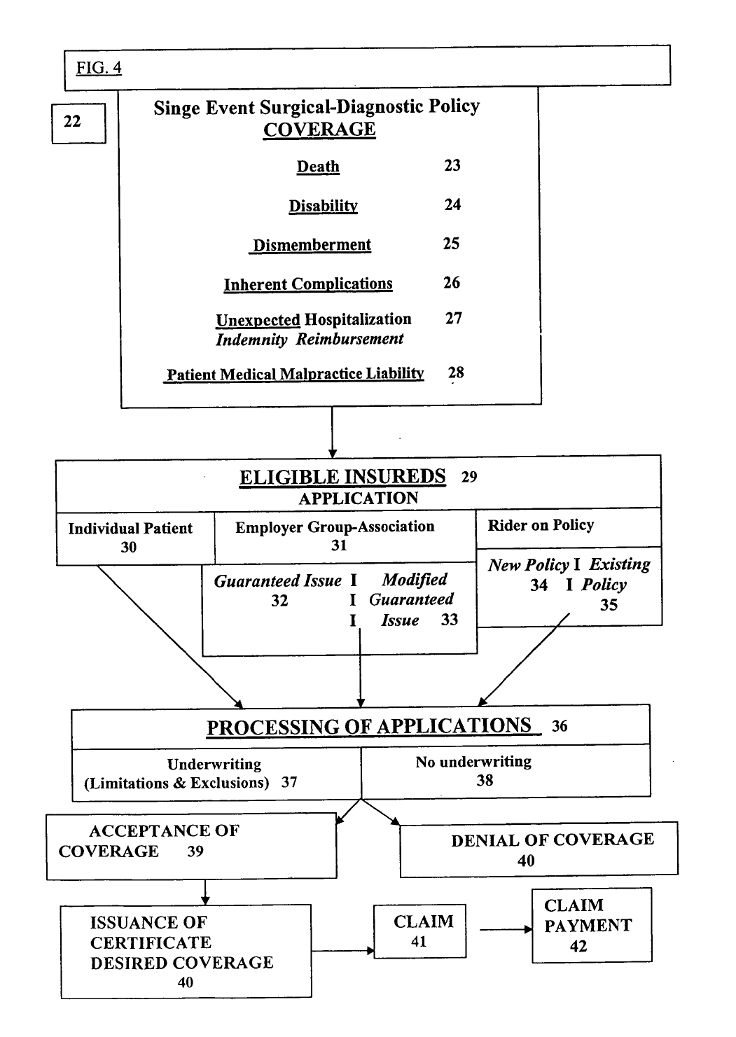

FIG. 4 illustrates one embodiment of a system for implementing the methods of the invention for assessing coverages, computing variances to determined coverages, minimize premiums to policy holders, maximize profits to the policy issuer, to issue policies, and process claims, in association with surgical events and diagnostic procedures.

As illustrated, a determination is made as to desired/offered policy coverage (22) to an insured. As illustrated, the desired/offered policy coverage could include one or all, death (23), short or long term disability (24), dismemberment (25), inherent complications of the covered procedure (26), unexpected hospitalization with either an indemnity or reimbursement benefit (27), and patient medical malpractice liability in the event there is a judgment awarded by a court of law (28), among other forms and types.

In accordance with one embodiment of the invention, the insured (29) completes some form of an application for coverage. In one embodiment, the application preferably includes a series of social, demographic, and medical questions.

The application may vary depending upon its type, including whether the application is for an individual insured, comprises a group or members of a group, and/or whether the policy is for a rider on an existing policy. A first application may be required for an individual patient (30). In the case of an employer group-association (31) there may include a contractual agreement when the policy will include a guarantee (32) or modified guaranteed (33). Riders on health related new policies (34) or existing policies (35) of the insured would be a contractual obligation of the respective insurer.

Generally, the application would also include the desired amount of coverage, the requested extent (12) and type (13) of coverage, benefit schedule (15), and type of policy (17) (see FIG. 2).

In accordance with this invention, the application data or contract will be processed (36) to determine if the insured is denied coverage or contract (40), or accepted for coverage or contract (39). During the application process (36) evaluation is made relative to the types of eligible insureds (29), including by considering independent variables, to determine if the insured will need further underwriting (37) due to limitations and exclusions of the Policy, or will not need further underwriting (38).

If the coverage/contract is to be issued, a premium is calculated. The premium payment is collected or debited to a new or existing account and a certificate of desired coverage are issued. When there is a triggering event of a covered surgical event or diagnostic procedure, the claim is entered and processed (41). In accordance with this invention, if a surgical event or diagnostic procedure claim is valid, the benefit amount of the claim 42) is paid to the insured (directly and/or indirectly).

In accordance with a preferred embodiment of the invention, when information regarding surgical event or diagnostic procedure claims is received, this information is entered into the system/utilized to determine an adjusted variance-covariance matrix. That information is utilized to find the minimum variance of the portfolio to minimize premiums to the insured and maximize profits of the insurer.

One aspect of the invention is a system configured to implement the methods of the invention. In one embodiment, the system is specifically configured to implement the methods of the invention. In another embodiment, the system may be configured to perform a variety of functions, including one or more methods of the invention and one or more other methods.

In one embodiment of the system includes at least one computing device. The computing device preferably includes at least one processor configured to execute computer readable program code (e.g. software). In one embodiment, the computer readable program code may be configured as part of hardware, such as by forming a portion of a processor. In another embodiment, the processor may be configured to execute separate code, such as code provided thereto from an external source.

In one embodiment, the system, such as the computing device, includes a data storage device. Preferably, the system, such as computing device, includes a short-term re-writeable memory, such as RAM, ROM, an EPROM or other types of volatile memory. The system, such as the computing device, may include a mass storage device, such as a hard disk. The hard disk may be used, for example, to store data regarding patients, policies, claims and similar information, as well as operating code for various program modules which are used by the processor to execute functions of the invention. The short-term memory may be used to store software code and other information for use by the processor when the processor is executing the code or utilizing the data.

In one embodiment, the various methods could be implemented by a single computing device, such as a workstation. In a preferred embodiment, however, the system comprises a plurality of devices which are configured to communicate with one another. For example, the system may include a main server or servers which include mass storage devices. A plurality of workstations may communicate with the servers. The workstations may be located remote from one another and from the server. In one embodiment, the a user of a workstation may access information from a server and provide information to a server. Programs may be executed at the workstation or executed centrally and with information transmitted to the workstation.

In this regard, the system preferably includes means for inputting information and for outputting information. The system may include keyboards, mouses, scanners, disk readers, touch screens and a variety of other input devices now known or later developed. The system may include displays, printers, card writers and a variety of output devices now known or later developed.

In one embodiment, applications may be printed on paper or provided on a similar type of medium. Information provided on the application may be entered into the system, such as by manual input or scanning. Application information might also be input directly into the system, such as into an electronic form. In one embodiment, applicants might access a website offering the form in electronic format, and input and transmit that information to the system for analysis.

Similarly, claims might be submitted on a medium (such as written request) or by electronic form or otherwise. Policies may be printed or transmitted as electronic documents.

Preferably, in such a system, computer readable or executable program code is configured to implement one or more methods of the invention, including determining suitability/risks associated with a procedure, including accepting, correlating and collating information regarding events (including both old and new information) to calculate posterior probabilities (such as by generation of a variance/co-variance matrix in accordance with Bayes' theorem), and to issue policies having a variety of components. The system preferably includes computer readable or executable program code for processing applications, including determining desired coverage, accessing possibility of coverage, issuing policies, accepting and processing claims, including tracking insureds, policies, events, premium payments and disbursements.

In accordance with the invention, a system and method and apparatus have been developed for providing dismemberment, death, disability, inherent complications of the specific surgery, unexpected hospitalization, and patient medical malpractice liability or other types of coverage for a surgical event or diagnostic procedure, considering the complexity of the process of writing coverage for the insured, including but not limited to the broad categories of developing limitations and exclusions of the policy, underwriting, premiums, benefit schedules, claims management, and data base collection.

One aspect of the system and method is to provide a system and method to collate statistics and probabilities on morbidity and mortality pertaining to surgical and diagnostic procedures to provide insurance coverage as a single event, for a large number of surgeries and procedures, and provide variety of benefit schedules. The system and method provide the opportunity to present policies having multiple forms of coverage for a single event surgery or diagnostic procedure with the lowest premium costs to the insured and highest profits to the insurer.

A unique aspect of the invention is a method and system for determining whether to issue insurance coverage for one or more specific events, such as a specific surgical event or diagnostic procedure, or several of such events or procedures, assessing risks associated with such events/procedures for determining whether to issue coverage, minimizing premiums and maximizing profits, and for determining the components of the policy to be issued. Of course, the terms “surgical events” and “diagnostic procedures” are far reaching, including a variety of events and procedures, including inpatient and outpatient procedures, a variety of medical or medical-related events.

In accordance with the invention, an insured is offered the opportunity for insurance against loss associated with a surgical event, diagnostic procedure or the like at the lowest possible premiums. At the same time, the system and method of the invention provide a way for policy issuers to assess risks and issue policies in a manner optimizing profitability.

In accordance with the invention, an insured may obtain more than one policy. A core policy may provide a lump-sum benefit in the event of including but not limited to death, short and long term disability, dismemberment, or any a complication inherent to the surgical and diagnostic procedure. A first supplemental policy may be configured to provide a reimbursement or indemnity schedule for hospitalization as a result of the procedure and its post operative period. A second supplemental policy may be configured to provide an indemnity and/or reimbursement schedule to provide coverage to the insured for an incidence of medical liability insurance related to the single event procedure.

Of course, the policy may include a variety of limitations or definitions which apply to the coverage of the surgical event or diagnostic procedure. For example, injury from the event/procedure may need to be unintentional regardless of cause. Nonetheless, in jurisdictions that allow a supplemental rider to insure a patient for damages in the event of a medical error or malpractice, such a rider may be offered.

The invention has particular applicability to a death benefits (or “life insurance”) policy which provides an insured coverage for risk of death associated with a surgical or diagnostic procedure or other medical event. In a preferred embodiment, the insured is guaranteed issuance of the policy without regard to whether the insured has other existing policies. In generating the policy, the above-described risk criteria may be assessed or considered and a number of pre-defined policy criteria may be selected. As indicated above, those criteria may be based at least partially on the risk criteria. The policy criteria may define the extent of coverage, exclusions, premiums, schedule of benefits and/or policy type, among others.

In one embodiment, the policy criteria may require that the insured (in order for a claim on the policy to be accepted): (1) utilize an accredited or approved physician/surgeon or other medical personnel and/or accepted or approved medical facility; (2) follow any pre- or post-procedure or event instructions, such as may be provided by pre- or post-event instructions forms which the insured may be required to sign or acknowledge at the time of the procedure or event and/or such as any required post-procedure or event checks or examinations; (3) obtain pre-procedure or event clearance (such as via a pre-procedure medical check or examination); and/or other criteria for limiting or reducing the probability of death from the procedure or event, including but not limited to human error, infections, etc. In this regard, a computing system may be used to generate pre- and/or post-procedure forms for particular procedures and issue those forms to the insured, as well as processed signed forms. The computing system may also be used to monitor post-procedure or event medical follow-ups, such as by receiving input of such an event from a physician upon completion of the event. The computing system may also be used to generate and issue approved lists of physicians or medical facilities which the insured may utilize consistent with the policy.

In another embodiment of the invention, the policy may be automatically or guaranteed to issue to the insured in the event the insured obtains a pre-procedure or event medical clearance and/or completes any required post-procedure or event follow-ups (i.e. issuance of the policy does not require that the insured meet any other qualification and the insured will not be denied the policy even if the insured does not meet other qualifications).

As one aspect of the invention, the insured may qualify for at least one supplemental or separate policy in the event the insured passes or completes the pre-procedure or event medical clearance and/or completes the required post-procedure or event follow-ups. The separate policy is preferably a health insurance policy which covers all or part of treatment for previously unknown medical conditions and/or complications or conditions arising from the procedure or event. This secondary policy may be issued upon application and payment of an additional premium by the insured, wherein the secondary policy may be guaranteed to issue if the insured obtained the required clearance and completed the required follow-ups, without regard to whether the insured meets other qualifications or not.

In such a configuration, at least one additional or tertiary insurance policy may be issued the insured, the at least one additional policy having a reduced premium in the event the insured does not make claims against the secondary insurance policy. For example, in the event the insured does not make any claims against the secondary health insurance policy for any complications or unknown medical conditions, the insured may qualify for a long-term health insurance policy at a reduced premium (compared to the cost of the premium if the insured did not originally obtain the life insurance policy and first associated health insurance policy).

In various configurations, the policies are preferably integrated into an overall quality of cost and care platform, which platform preferably includes approved physicians and medical facilities. For example, such a policy may be associated with a quality of cost and care platform where physicians and facilities must meet certain cost and quality guidelines or standards, wherein the policy only covers procedures or events by those physicians and at those facilities. In this manner, the risks associated with the procedure or event are reduced because the entity requires the physicians and facilities to maintain certain standards and follow certain procedures and guidelines. Thus, associated policies can be issued to insureds more cost-effectively. In addition, in accordance with this relationship between insurance and medical services, the cost of medical care may be managed and reduced. In particular, because in order for a patient to have valid insurance coverage the patient must use approved physicians and medical facilities and follow required care instructions and procedures, there is a higher probability of successful treatment, thus lowering the costs associated with the procedure or event.

While the various aspects of the invention have been described with specific application to insurance coverage for single event surgical and diagnostic procedures, it is contemplated that the various aspects of the invention (including, for example, methods of determining coverage and evaluating risks) may be applied to other applications/environments, including policies other types and even applications outside of insurance coverage analysis.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A method of an insurance provider providing a life insurance policy providing insurance coverage to an insured for risk of death associated with a surgical or diagnostic procedure or medical event utilizing a computer system, comprising:
determining if said insured has any life insurance component of an existing insurance policy, including existing voluntary and/or involuntary life, health, or accidental death and dismemberment policies;
guaranteeing issuance to said insured of said life insurance policy relative to said surgical or diagnostic procedure or medical event without regard to any additional information based on the criteria that the insured has an existing policy;
utilizing computer readable program code to assess, at said computer system managed by said insurance provider, assessing a plurality of risk criteria associated with said surgical or diagnostic procedure or medical event, said criteria defined by data stored in a memory device associated with said computer system and comprising one or more of: ICD-10CM diagnostic codes; CPT procedural codes for surgical or diagnostic procedures or medical events and diagnostic procedures; ASA and NYHA patient anesthesia risk assessment indexes; certification of the provider of the surgical or diagnostic procedure or surgical event or diagnostic procedure; national vital statistics on the number and type of surgical or diagnostic procedures or medical events; actuarial tables for life expectancy; certification of a facility at which said surgical or diagnostic procedure or medical event is to take place; and data for surgical or diagnostic procedure or medical event mortality and morbidity;
determining via said computer system pre-defined policy criteria for said policy based at least partially upon said plurality of risk criteria, said pre-defined policy criteria comprising: (1) extent of coverage; (2) exclusions; (3) premiums; (4) schedule of benefits; and (5) policy type, and said criteria including that said insured follow provided instructions for said procedure or event, including any post-procedure or event follow-up examination, obtain pre-approval for said procedure or event, and utilize an approved provider or facility, wherein said life insurance policy comprises a new policy for coverage for losses arising from death resulting from said surgical or diagnostic procedure or medical event if said insured has no existing insurance coverage and wherein said policy comprises a new or existing rider in the event said insured has existing insurance coverage;
generating said policy having said pre-defined policy criteria via said computer system and storing information regarding said policy at said computer system;
presenting said policy which was generated by said computer system;
processing, via said computer system, an application for said policy for insurance coverage from said insured for said surgical or diagnostic procedure or medical event including determining whether to issue a policy or deny coverage by inputting application information regarding said policy into said computer system; and
if a policy is issued and said insured dies, accepting a claim into said computer system upon said policy based upon said act, processing said claim using said computer system, and if said claim is determined to be valid, including compliance with said policy criteria by said insured, using said computer system to issue payment for paying said predetermined fixed claim to said insured without regard to claims by said insured to other sources of compensation, including any existing insurance.

2. The method in accordance with claim 1 further comprising the step of assessing risk criteria via said computer system comprising determining if said insured is eligible for a life insurance component of an existing insurance policy, including an existing voluntary and/or involuntary life, health or accidental death or dismemberment policies.

3. The method in accordance with claim 1 further comprising assessing risk criteria via said computer system comprising determining if said insured is having a surgical or diagnostic procedure or event with reference to pre-authorization CPT and ICD codes.

4. The method in accordance with claim 1 further comprising assessing risk criteria via said computer system comprising determining if said insurance is eligible for a life insurance component and, if so, transforming said eligibility into coverage for said surgical or diagnostic procedure or event.

5. The method in accordance with claim 1 further comprising determining, via said computer system, said pre-defined policy criteria to minimize risks and maximize profits associated with said one or more policies.

6. The method in accordance with claim 1 further comprising the step of accepting a premium from an insured and providing premium payment information to said computer system as part of said processing of said application.

7. The method in accordance with claim 1 further comprising the steps of generating a predetermined premium amount for said policy using said computer system and accepting said a predetermined premium if said application for policy is accepted.

8. The method in accordance with claim 1 further comprising assessing risk criteria via said computer system using past and new information regarding risks associated with said surgical or diagnostic procedure or medical event or diagnostic procedure including utilizing Bayes' theorem to generate a variance matrix for determining posterior probabilities.

9. The method in accordance with claim 1 wherein said policy is issued as part of a quality and cost of care platform which includes managing approved providers and facilities.

10. The method in accordance with claim 1 including generating a list of approved providers and facilities for said surgical or diagnostic procedure or medical event.

11. The method in accordance with claim 1 including generating one or more instruction forms regarding pre- or post-operative care steps which must be followed by said insured.

12. The method in accordance with claim 1 wherein said policy criteria comprise at least one pre-procedure or event physician medical clearance and at least one post-procedure or event follow-up visit which must be followed by said insured.

13. A method of an insurance provider providing a life insurance policy providing insurance coverage to an insured for risk of death associated with a surgical or diagnostic procedure or medical event utilizing a computer system, comprising:
utilizing computer readable program code to assess, at said computer system managed by said insurance provider, assessing a plurality of risk criteria associated with said surgical or diagnostic procedure or medical event, said criteria defined by data stored in a memory device associated with said computer system and comprising one or more of: ICD-10CM diagnostic codes; CPT procedural codes for surgical or diagnostic procedures or medical events and diagnostic procedures; ASA and NYHA patient anesthesia risk assessment indexes; certification of the provider of the surgical or diagnostic procedure or surgical event or diagnostic procedure; national vital statistics on the number and type of surgical or diagnostic procedures or medical events; actuarial tables for life expectancy; certification of a facility at which said surgical or diagnostic procedure or medical event is to take place; and data for surgical or diagnostic procedure or medical event mortality and morbidity;
determining via said computer system pre-defined policy criteria for said policy based at least partially upon said plurality of risk criteria, said pre-defined policy criteria comprising: (1) extent of coverage; (2) exclusions; (3) premiums; (4) schedule of benefits; and (5) policy type, and said criteria including that said insured follow provided instructions for said procedure or event, including any post-procedure or event follow-up examination, and utilize an approved provider or facility, wherein said life insurance policy comprises a new policy for coverage for losses arising from death resulting from said surgical or diagnostic procedure or medical event if said insured has no existing insurance coverage and wherein said policy comprises a new or existing rider in the event said insured has existing insurance coverage;
guaranteeing issuance to said insured of said life insurance policy relative to said surgical or diagnostic procedure or medical event without regard to any additional information based on the criteria that the insured has an existing policy;
determining if said insured has obtained a pre-procedure or event medical clearance and, if so, using said clearance as the sole basis for issuing said policy to said insured, said policy having said pre-defined policy criteria via said computer system and storing information regarding said policy at said computer system;
presenting said policy which was generated by said computer system;
processing, via said computer system, an application for said policy for insurance coverage from said insured for said surgical or diagnostic procedure or medical event including determining whether to issue a policy or deny coverage by inputting application information regarding said policy into said computer system; and
if a policy is issued and said insured dies, accepting a claim into said computer system upon said policy based upon said act, processing said claim using said computer system, and if said claim is determined to be valid, including compliance with said policy criteria by said insured, using said computer system to issue payment for paying said predetermined fixed claim to said insured without regard to claims by said insured to other sources of compensation, including any existing insurance.

14. The method in accordance with claim 13 wherein said policy criteria further comprises at least one post-procedure or event follow-up medical check of said insured.

15. The method in accordance with claim 14 further comprising the step of issuing at least one health insurance policy to said insured based upon said pre-procedure or event clearance and said at least one post-procedure or event follow-up medical check, said health insurance policy covering all or part of treatment for previously unknown medical conditions.

16. The method in accordance with claim 15 further comprising the step of issuing at least one additional insurance policy to said insured, said at least one additional policy having a reduced premium in the event said insured does not make claims against said at least one health insurance policy.
